(19) United States
(12) Patent Application Publication
(10) Pub. No.: US 2004/0161330 A1
(43) Pub. Date: Aug. 19, 2004

(54) Pallet

(76) Inventors: Thilo Hahn, Dettelbach (DE); Kurt Georg Nagler, Wurzburg (DE); Johannes Georg Schaede, Wurzburg (DE); Peter Eugen Wagner, Grunsfeld (DE)

Correspondence Address: Douglas R Hanscom, Jones Tullar & Cooper, Eads Station, P O Box 2266, Arlington, VA, 22202, US

(21) Appl. No.: 10/476,183

(22) PCT Filed: Apr. 4, 2002
(86) PCT No.: PCT/DE02/01220

(30) Foreign Application Priority Data
May 12, 2001 (DE) 101 23 328.0

(51) Int. Cl. B65G 59/02

(52) U.S. Cl. 414/796.9

(57) ABSTRACT

A pallet includes a support plate that is provided with supporting projections which are arranged on a main or primary side of the support plate, which is configured as a supporting surface that is intended for bearing a load. These projections are tapered toward free ends. The projections facilitate stacking of plural pallets spaced from each other either at a small spacing distance or at a large spacing distance. Recesses are formed on a secondary side of the support plate, opposite the supporting surface. These recesses receive the free ends of the projections.

The invention relates to a pallet in accordance with the preamble of claims 1, 4 or 11.

Stackable pallets, each with a base plate and support projections formed at a first main side of the pallet, which taper toward a free end, and with recesses for receiving the support projections of another pallet on the opposite second main side, are known from WO 98/28197 A1and EP 0 725 027 B1. Each of these support projections is shaped in such a way that, depending on the orientation with which the pallets are stacked on top of each other, they make possible either a stack formation with large spacings between pallets, wherein space for placing the flat material remains between two pallets, or a stack formation with little or even vanishing spacing by means of the support projections entering into the recesses of another pallet, in order to store the unused pallets in a space-saving manner.

Such pallets are particularly employed in connection with the printing of banknotes or similar securities, in order to store and process stacks of sheets of paper of an exactly counted number of sheets.

With the known pallets, the support projections are formed on the underside of the pallet and extend downward against a pad or a pallet located underneath, and the top of the pallet is designed as a base surface for supporting a stack of sheets.

For separating such a stack by machine and to remove the individual stacks of sheets, it is necessary to be able to separate individual pallets from the stack.

A lifting device comprising a plurality of arms is employed for this, which are respectively moved from the side against the support projections of a pallet and which are capable, once they are in contact with the support projections, to support the pallet they have contacted, so that a pallet located underneath can be lowered and pulled out from underneath the stack.

The downwardly tapering shape of the support projections is necessary to make it possible in the tightly stacked state to insert them into the recesses of the pallet top. However, a consequence of this shaping is that the support projections at the base plate have a base surface of considerable extent, and that in their vicinity there is only little horizontal space available for making a stable support of the pallet on the arms possible.

DE 92 17 413 U1 shows a stackable packaging unit with a pallet with downward oriented feet, on which upward oriented lateral walls can be placed.

DE 28 01 077 A1 describes a stackable transport container, whose support faces are tapered and oriented upward.

The object of the invention is based on producing a pallet.

This object is attained in accordance with the invention by the characteristics of claims 1, 4 or 11.

The advantages to be gained by means of the invention lie in particular in that, with identical lengths of the edges of the pallet and of the above cited known pallets, and without a loss of stacking surface for the flat material, the contact surface on which a pallet can be supported by an arm during unstacking, or separating a stack, is clearly increased, so that the dependable manipulation of the pallet stack is possible.

This advantage is obtained in that the main side of the pallet on which the support projections are formed is simultaneously embodied as the support surface for carrying a load. In other words, the support projections are located on the top of the pallet and are upwardly oriented and come together in a point at the top, while with conventional pallets they are located on the underside and come together in a point at the bottom. If arms are inserted under a pallet for lifting it during unstacking, only the narrow tip of the support projections limits the forward movement of the arms, i.e. the arms can be inserted deeper under the pallets than before and assure a secure placement of the pallets they carry.

In accordance with a preferred embodiment, in addition to the support projections, its support plate is equipped with downward oriented feet for supporting a pallet on a pad.

With this design, respectively one of the support projections, or one of the recesses, is embodied on every foot. In this way only little surface is required in the edge area of the pallet for the feet and support projections, and the material to be stacked can be loaded on and off the pallet by lateral displacement off the pallet and largely unhindered by the feet and support projections.

Moreover, each foot preferably has a load surface section, which is connected with the base plate by sloping walls, and the support projection and the recess are each formed in the load surface section. Because of the engagement of the feet with each other, this construction allows a space-saving stacking of empty pallets.

With this construction, a base surface of each support projection can extend as far as the edge of the load surface section without a loss of stability when the pallets are lifted. In comparison with conventional pallets with support projections oriented downward, this allows a reduction of the edge dimensions or an increase in the dimensions of the support projections, because of which a greater degree of stability of the support projections, and therefore an improved stackability, are achieved.

Preferably a downward oriented apron is formed on the lateral edges of the base plate. The height of the apron approximately corresponds to that of the support projections or, if provided, of the feet. The aprons prevent an unauthorized access to a stack of flat materials located underneath the pallet. The carrying capacity of a pallet, and therefore the maxim height of a stack formed of such pallets is improved in that the aprons are connected with the respective adjoining sloping walls of the feet.

An exemplary embodiment of the invention is represented in the drawings and will be described in greater detail in what follows.

Shown are in:

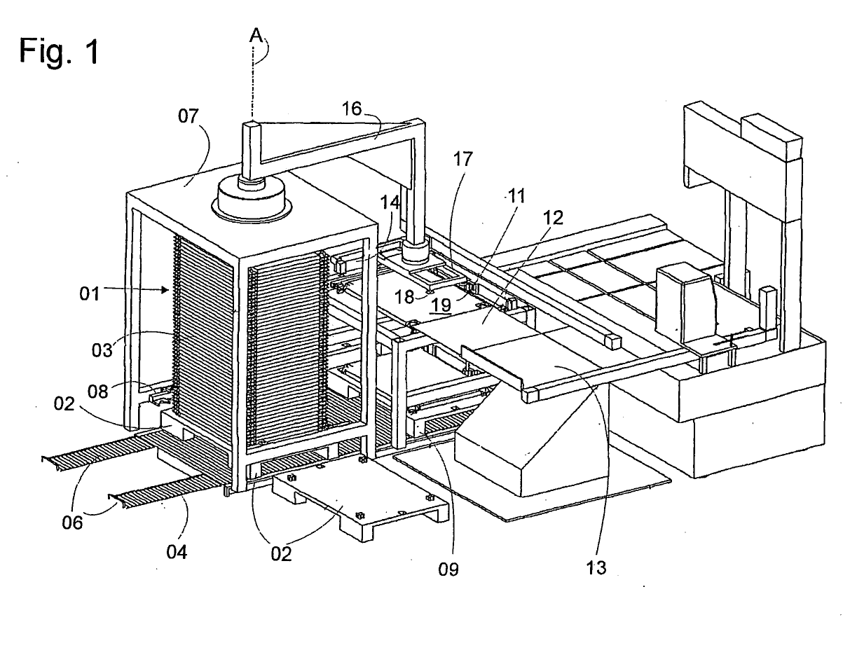

FIG. 1, a perspective plan view of a processing installation, in which a stack of pallets in accordance with the invention is unstacked and sheets stored on the pallets are unloaded and forwarded for further processing,

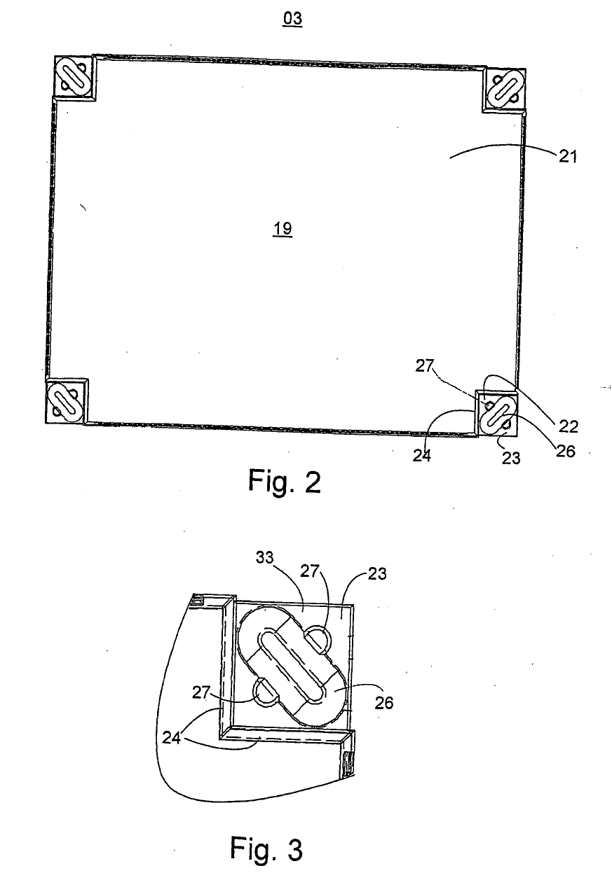

FIG. 2, a view from above on a pallet,

FIG. 3, a detail of the pallet in FIG. 2 in a view from below,

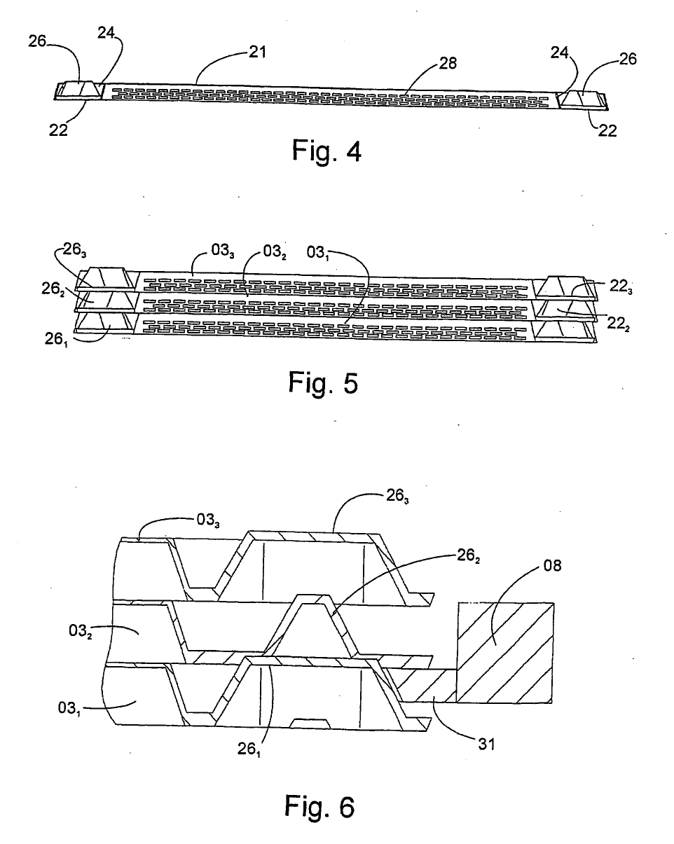

FIG. 4, a lateral view of the pallet in FIG. 2,

FIG. 5, a stack of three pallets stacked at the large second spacing,

FIG. 6, a section through a corner area of the stack in FIG. 5,

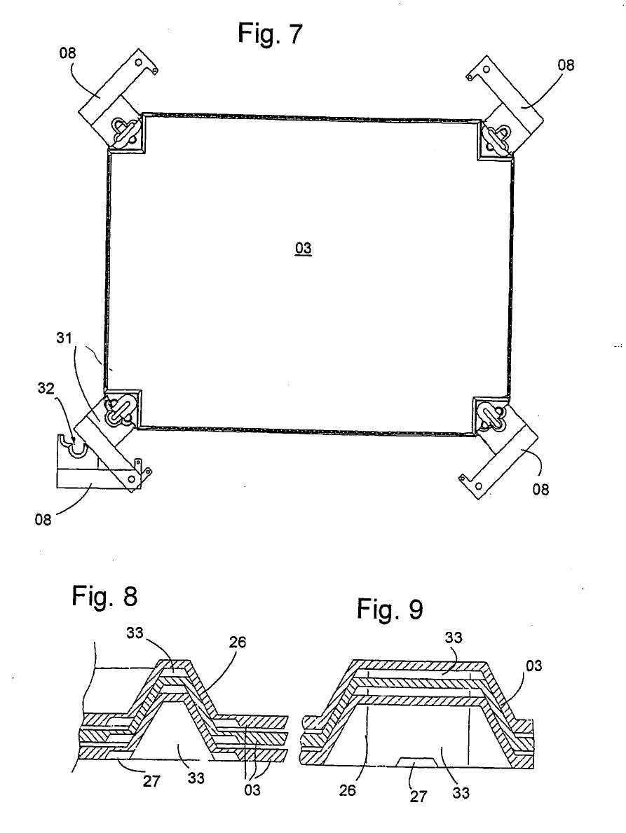

FIG. 7, a view from above on the pallet in FIG. 2, with arms of the unstacking arrangement in FIG. 1 inserted and in contact with the support projections,

FIGS. 8, 9, respective sections analogous to that in FIG. 6 through three pallets stacked at the first short spacing.

An installation for unstacking a stack of pallets and for the removal and further processing of stacks of sheets stored on the pallets is represented in FIG. 1.

A stack 01 comprises a plurality of pallets 03 stacked on top of each other on a base support 02. For processing, such a stack 01 is unloaded onto two roller tracks 06 in a storage position 04 at the entry of the installation. The stack 01 is pushed on these roller tracks 06 into the position shown in FIG. 1 in the interior of an unstacking arrangement 07. In this case the unstacking arrangement 07 is in the form of a substantially cuboid-shaped frame, in whose interior four arms 08 are mounted, of which only one can be clearly seen in FIG. 1. Each arm 08 embodied as a gripper can be pivoted in respect to a corner of the stacked pallets 03. The stack 01 can be displaced in height inside the unstacking arrangement 07, so that the arms 08, which are mounted at a fixed height, can each be inserted into a space between the lowermost and second lowermost pallet 03 of the stack 01.

Following the introduction of the arms 08, the lowermost pallet 03 is lowered together with the base support 02 on which it rests in order to come free of the arms 08 and is displaced into the position identified by 09 in FIG. 1. In the process the arms 08 support the remaining stack 01.

The pallet 03 is lifted out of the position 09 into a position in which a further pallet 11 is represented in FIG. 1. The support surface 19 of the pallet 11 is flush with a transfer plate 12, over which a stack of sheets (not represented) located on the support surface 19 is displaced by means of a pusher 14 to a vibrating table 13, for example, preferably to a sheet delivery, and is moved on from there for further processing. Since this further processing is not a subject of the invention, it will not be further described here.

Following the lifting of the pallet 11 into position, the base support 02 is moved back underneath the stack 01 and is lifted until it supports the weight of the stack 01 and the arms 08 are relieved. The latter are now pulled out from underneath the stack 01. A further work cycle of the unstacking arrangement 07 begins with the lowering of the stack 01 by one pallet spacing and the renewed introduction of the arms 08 between the lowermost and second lowermost pallet 03.

A gripper arm 16 is mounted on the top of the unstacking arrangement 07 so it is pivotable toward the viewer around an axis A by approximately 90° from the position shown in FIG. 1. On its free end, the gripper arm 16 has a gripper shell 17, which here has the shape of a square frame with suction cups 18 respectively arranged at the corners of the frame, which can be charged with a partial vacuum. The gripper shell 17 can be lowered for grasping the unloaded pallet 11 by means of the suction cups 18, lifting it, pivot it by rotating around the axis A above a base support 02, which is represented as empty next to the unstacking arrangement 07 in FIG. 1 and on which a stack of empty pallets is to be built up, and lower the pallet 11 onto it. In the course of loading a pallet 11 onto a stack of empty pallets, alternatingly the orientation of the pallet 11 is either maintained, or the pallet 11 is rotated by 180° in order to stack the pallets in this way at a vertical distance which is less than the distance between the pallets 03 in the stack 01. How this is possible will be made clear later in connection with the description of the structure of the pallets 03, 11.

The installation represented in FIG. 1 allows unstacking without interruption, since a multitude of the above described steps can be performed at the same time on different pallets 03, 11. It is possible for one to already load a further stack in the storage position 04 while the stack 01 is separated in the unstacking position 07. While the respectively lowermost pallet 03 is removed from the stack 01 with the aid of the arms 08, the pusher 14 can simultaneously push the stack of sheets off the previously separated pallet 03 and, while the emptied pallet 11 is brought to the stack of empty pallets, the next pallet 03 can be lifted out of the position 09 into the unloading position of the pallet 11.

FIG. 2 shows a view from above on a pallet 03. The pallet 03 is essentially constituted of a support plate 21 with a layout in the form of a cross with wide arms, or a rectangle with the corners cut away. The upward facing support surface 19 of the support plate has been carefully smoothed, so that a stack seated thereon can be laterally pushed off without damage, and the pallet 03 can be dependably grasped by the suction cups 18 of the gripper arm 16.

Four feet 22 are arranged in the area of the cut-away corners, each of which has a flat load surface section 23 for the placement of the pallet 03 on a flat pad and is connected with the support plate 21 via sloping walls 24 extending at right angles in respect to each other, this can be seen more clearly in the detailed view of FIG. 3, which shows the right upper edge of the pallet from FIG. 2.

A large portion of the load surface section 23 is taken up by a support projection 26, which has an elongated shape, oriented at an angle of 45° in respect to the longitudinal edges of the pallet 03 and tapering toward the top. The support projections 26 of the four feet 22 are each oriented in pairs at an angle of 90° in respect to each other. The support projection 26 and the indentations 27 formed on it are hollow, a recess 33 of a complementary shape is located at the underside of the load surface section 23, as can be seen in the sectional views of FIGS. 6, 8 and 9 in particular.

FIG. 3 shows a load surface section 23 in a view from below. Two indentations 27 of little depth are formed on the longitudinal sides of the recess 33. Depending on the orientation with which two pallets 03 are stacked on top of each other, a support projection 26 of the lower pallet 03 either engages the recess 33, in which it is practically completely contained, or the two indentations 27. In the first case the result is a stack with little spacing, in the latter case with a large spacing.

FIG. 4 shows a lateral view of the pallet 03. A plate-shaped apron 28 extends from the edge of the support plate 21 obliquely outward and downward. The apron 28 has a plurality of openings which permit a view of the space underneath the support plate 21. The lateral ends of the apron 28 are each connected with the sloping wall 24 of a foot 22, because of which the apron 28 also contributes to the bearing capability of the support plate 21.

FIG. 5 shows lateral views analogous to FIG. 3 of three pallets 03₁, 03₂, 03₃ stacked on top of each other. The tips of the support projections 26₁, 26₂, 26₃ of each pallet 03₁, 03₂, 03₃ extends slightly past the level of the support surface 19 of the pallets 03₁, 03₂, 03₃. In a working position, the feet 22 point upward, wherein the top of the feet 22 is approximately at the same level as the support plate 21.

The tops of the feet 22 are arranged within a range of 20 mm above to 20 mm below, in particular in a range of 10 mm above to 10 mm below, the top of the support plate 21. The pallets 03₁, 03₂, 03₃ are placed on top of each other with alternating orientations of support projections 26₁, 26₂, 26₃ located on top of each other, so that the elongated tip of each support projection 26₁, 26₂, 26₃ engages the indentations 27 of the foot 22₂, 22₃ located above it.

This arrangement is represented in an enlarged sectional view in FIG. 6. The section extends in the direction of the median line of a pallet corner. It therefore shows the support projection 26₁ of the lower pallet 03₁ in longitudinal section, the support projection 26₂ of the pallet 03₂ located above it in cross section, and the support projection 26₃ of the topmost pallet 03₃ again in longitudinal section.

FIG. 7 shows a plan view of a pallet 03 from below in the state where it is supported on arms 08. The arms 08, each of which is pivotable around an axis A, have a claw 31 for insertion underneath the pallet 03 which has a cutout 32, approximately T-shaped in a view from above, whose shape has been selected to be such that it can closely extend around the upper area of a support projection 26 supporting the pallet 03 in both its possible orientations.

The sectional view of FIG. 6 shows such a claw 31, which supports the pallet 03₂ and in the process rests closely on the projection 26₁ of the pallet 03₁. As can be easily seen by means of FIG. 6, for lifting the pallets 03₂, 03₃ off the pallet 03₁ it is sufficient to set the height of the pallet stack in such a way that the claws 31 can be introduced between the pallets 03₁ and 03₂, to push them in until they run up against a support projection 26₁, and then to lower the pallet 03₁.

FIGS. 8 and 9 show, respectively in the longitudinal or transverse direction of the support projections 26, a sectional view through the support projections 26 of three pallets 03 stacked on top of each other with short spacing. Since each of the support projections 26 has the same orientation, they can enter deeply into the complementary recesses 33 of the pallet 03 respectively seated on them, so that the result is compact stacking with a low stack height.

Lists of Reference Symbols

01 Stack

02 Base support

03 Pallet

04 Storage position

05 -

06 Roller tracks

07 Unstacking arrangement

08 Arm

09 Position

10 -

11 Pallet

12 Transfer plate

13 Vibrating table

14 Pusher

15 -

16 Gripper arm

17 Gripper shell

18 Suction cup

19 Support surface

20 -

21 Support plate

22 Foot

23 Load surface section

24 Wall, sloping

25 -

26 Support projection

27 Indentation

28 Apron

29 -

30 -

31 Claw

32 Cutout

33 Recess

03₁ Pallet

03₂ Pallet

03₃ Pallet

22₂ Foot

22₃ Foot

26₁ Support projection

26₂ Support projection

26₃ Support projection

A Axis

1. A pallet (03) with a support plate (21) and feet (22), wherein the feet (22) point upward in a working position, characterized in that the tops of the feet (22) are arranged in a range of 20 mm above to 20 mm below the top of the support plate (21), and a downwardly pointing apron (28) is formed on each of the lateral edges of the support plate (21).

2. A pallet (03) with a support plate (21) and feet (22), wherein the feet (22) point upward in a working position, wherein the tops of the feet (22) are approximately arranged at the same level as the support plate (21), characterized in that support projections (26) are formed on a main side of the pallet (03), which taper toward a free end and make possible a supported contact with a second pallet, selectively at a small first, or a large second vertical spacing between the pallets (03), and having recesses (33) formed on the opposite second main side of the pallet (03) for receiving the support projections (26) of a third pallet (03) in the course of stacking at a first spacing, wherein the main side of the pallet (03) on which the support projections (26) are formed are simultaneously embodied as a support surface (19) for supporting a load.

3. The pallet in accordance with claim 1, characterized in that the tops of the feet (22) are arranged in a range of 10 mm above to 10 mm below the top of the support plate (21).

4. A pallet with a support plate (21) and feet (22), as well as at least one apron (08), wherein in the working position the feet (22) point upward and the apron (28) points downward characterized in that respectively one support projection (26) and one recess (33) are embodied on each foot (22).

5. The pallet in accordance with claim 4, characterized in that support projections (26) are formed on a main side of the pallet (03), which taper toward a free end and make possible a supported contact with a second pallet, selectively at a small first, or a large second vertical spacing between the pallets (03), and having recesses (33) formed on the opposite second main side of the pallet (03) for receiving the support projections (26) of a third pallet (03) in the course of stacking at a first spacing, wherein the main side of the pallet (03) on which the support projections (26) are formed are simultaneously embodied as a support surface (19) for supporting a load.

6. The pallet in accordance with claim 4, characterized in that each foot (22) has a load surface section (23), which is connected by means of sloping walls (24) with the support plate (21), and that the support projection (26) and the recess (33) are formed in the load surface section (23).

7. The pallet in accordance with claim 6, characterized in that a base surface of each support projection (26) extends up to the edge of the load surface section (23).

8. The pallet in accordance with claim 2, characterized in that a downwardly pointing apron (28) is formed on each of the lateral edges of the support plate (21).

9. The pallet in accordance with claim 8, characterized in that each of the aprons (28) is connected to adjoining sloping walls (24) of the feet (22).

10. A method for separating a stack (01) of pallets (03), comprising the steps of introducing arms (08) underneath a first pallet (03) of the stack (01) and of removing the first pallet (03) from a second pallet (03) located underneath it, characterized in that for supporting the first pallet (03), the arms (28) are moved against support projections (26) of the second pallet (03).
